(19) United States
(12) Patent Application Publication
(10) Pub. No.: US 2006/0019005 A1
(43) Pub. Date: Jan. 26, 2006

(54) Dry patterned coating processes and products

(76) Inventor: Michael L. Talbot, Dublin, OH (US)

Correspondence Address: WINSTON & STRAWN LLP, 1700 K STREET, N.W., WASHINGTON, DC, 20006, US

(21) Appl. No.: 10/894,310

(22) Filed: Jul. 20, 2004

(51) Int. Cl. A23G 3/28

(52) U.S. Cl. 426/383

(57) ABSTRACT

Processes for preparing partially dry-coated confectionery products by moving a confectionery product while providing a plurality of discrete, non-liquid particles in a visually distinct pattern upon a portion but not all of an outer surface comprising at least one side of the confectionery product, wherein the particles are adhered to the portion of the confectionery product to provide the visually distinct pattern compared to the confectionery product. Also included are dry-coated frozen confectionery products a dry, adhesive coating deposited in a desired pattern adjacent an outer surface of a confectionery product; and a plurality of discrete particles placed adjacent the adhesive coating and opposite the adhesive coating from the confectionery product, which are sufficiently adhered thereto to substantially remain affixed to the product in a visually distinct pattern.

### FIELD OF THE INVENTION

This invention relates to a process for preparing a partially dry-coated confectionery product with a visually distinct pattern of discrete, non-liquid particles, as well as products containing the same.

### BACKGROUND OF THE INVENTION

The history of freezing food products is detailed and it is well known in general to freeze foods and prepare foods for freezing. Frozen foods, frozen meals, and methods of preparing the same are known in the art in general. Many different kinds of frozen food products are available in the market or described in the prior art, and a few of these are described below in more detail.

U.S. Pat. No. 3,363,586 discloses a method and apparatus for providing decorated bars of confection. The method involves extruding and severing shaping bars and applying measured amounts of edible decorative particles by dropping them onto the moving bars in timed relationship to the severing step, after which the bars are solidified to a hardened condition.

French Publication No. 2,334,509 A discloses a process for decorating cakes or other confectionery, pastry, or bakery products on edible supports such as unleavened bread by printing the support with appropriate solutions such as different colors to form a decoration with a brush or stencil, then sprinkling a dry, powdered edible product to cover the wet areas before the solution is fully dry. The powder adheres to the wet surface to form a relief without adhering to the unprinted areas or dry parts. Also disclosed is that thick pastes and a metal stencil must be used.

UK Patent Application No. GB 2,332,133 A discloses an edible composition for use in finishing icing or decorative sugars including a non-hydrogenated vegetable oil or petroleum-based oil, a hard white wax, and an alcohol. A preferred composition includes sunflower oil, white beeswax, and isopropyl alcohol. This provides a waxy paste that is applied along with coloring agents and metallic finishing agents in sugarcraft work.

International Application No. WO 00/64271 discloses aerated confections in the form of pieces having a body color and exterior surface at least a portion of which has been modified to provide an appearance disparate to the body, which confections include 50 to 98 percent of a saccharide component, about 0.5 to 30 percent of a structuring agent, and about 1 to 8 percent moisture. The distinguishing feature is either color, texture, or structure. The confections are prepared by providing a mass of aerated confection pieces having at least one colored portion and having an external surface at least one portion of which is sticky, applying particles of a coating at least a fraction of which have a second color to adhere the particles to the sticky portion of the surface, and forming the coated aerated confection pieces into finished non-sticky coated pieces, such as for use in children's ready-to-eat cereals.

International Application No. WO 01/82717 discloses methods for making chocolate-flavored confectionaries by coating at least a particle with alternate layers of fats and powder including cocoa.

U.S. Pat. No. 6,242,026 discloses a method of creating food product, such as pizza, with illustrated, decorative features using edible symbols, granules, or powder. The edible symbols, granules, or powder, which may have coloring, are applied to the surface of food products by a symbol placement applicator that applies precut symbols and/or a stencil placement applicator to form designs. The edible symbols, granules, or powder are fused to the food product during a thermal fusing process.

In spite of these disclosures, it has not heretofore been possible to provide dry-coated patterns onto products, particularly frozen confectionery products, in rapid manner. Thus, there exists a need for improved methods and products for providing dry-coated patterns on products, such as frozen confectionery products.

### SUMMARY OF THE INVENTION

The present invention relates to a process for preparing a partially dry-coated confectionery product by moving a confectionery product while providing a plurality of discrete, non-liquid particles in a visually distinct pattern upon a portion but not all of an outer surface comprising at least one side of the confectionery product, wherein the particles are adhered to the portion of the confectionery product to provide the visually distinct pattern compared to the outer surface of the confectionery product.

In one embodiment, the particles are provided on the confectionery by providing an adhesive, edible material in the visually distinct pattern that is sufficiently tacky to retain the particles thereon, and adhering the discrete, non-liquid particles onto the tacky pattern to form the partially dry-coated confectionery product. In a preferred embodiment, the process further includes covering the confection with a fat-based coating before adhering the discrete-non-liquid particles. In another preferred embodiment, the pattern is provided by spraying, pad stamping, brushing, or a combination thereof, the adhesive, edible material onto the confectionery product in the visually distinct pattern. In more preferred embodiments, the pattern can be provided using a stencil, spinning cup, spinning pipe, spinning disk, or by controlled melting of a portion of the outer surface of the confectionery product to provide the adhesive, edible material to which the discrete, non-liquid particles adhere.

In these embodiments, the particles can be applied by at least one of disposing or projecting a shower of discrete particles onto the outer surface of the confection. In another embodiment, the process further includes moving the confectionery product and then providing the pattern, applying the particles, or both, while the confectionery product is in motion. In a preferred embodiment, the moving includes rotating, moving horizontally, moving vertically, or a combination thereof. In yet another preferred embodiment, the pattern is provided on at least two different sides of the confectionery product and the particles are applied onto the pattern concurrently onto the at least two different sides of the confectionery product.

In another embodiment, the particles that are applied are first particles having a first appearance, and the process further includes sequentially applying a plurality of second particles having a second appearance that visually contrasts with the first particles. In yet another embodiment, the process further includes drying the adhesive, edible material and surrounding the coated product in a packing material, with sufficient drying to avoid sticking of the patterned edible material to the packing material.

In another aspect of the invention, the particles are provided on the confectionery by dry-coating the outer surface of a confectionery product with a plurality of discrete, non-liquid particles and selectively removing a sufficient amount of the particles to create a desired pattern of particles that is visually distinct from the confectionery product. In one embodiment, the selective removing includes directing an air flow at the particles, suctioning the particles, brushing the particles, scraping the particles, or a combination thereof. In one embodiment of the invention, the visual distinctness includes providing a plurality of first particles and a plurality of second particles with different colors, shapes, or both.

In another aspect of the invention, the particles are provided on the confectionery by providing an adhesive, edible material in a different pattern that is sufficiently tacky to retain the particles thereon, adhering the discrete, non-liquid particles onto the tacky pattern, and providing an opaque, edible coating so at to leave exposed the visually distinct pattern of discrete, non-liquid particles to form the partially dry-coated confectionery product.

In one embodiment, the particles are permanently attached to the tacky adhesive, edible material. In a preferred embodiment, the particles are provided so as to also impart textural distinctness from the outer surface of the confectionery product.

The invention also encompasses a dry-coated frozen confectionery product including a dry, adhesive coating deposited in a desired pattern adjacent an outer surface of a confectionery product, and a plurality of discrete particles placed adjacent the adhesive coating and opposite the adhesive coating from the confectionery product, which are sufficiently adhered thereto to substantially remain affixed to the product in a visually distinct pattern.

In one embodiment, the discrete particles provide a raised texture to the outer surface of the confectionery product. In another embodiment, a fat-based coating is provided upon an outer surface portion of the confectionery product. In a preferred embodiment, the fat-based coating includes chocolate, a substantially transparent material, or both. In a preferred embodiment, the adhesive coating includes an oil-based coating or water-based syrup, or a combination thereof. In yet another preferred embodiment, the particles include cake fragments, cookie fragments, diced nuts, confectionery sprinkles, chocolate vermicelli, candy fines, seeds, or fruit fragments, or a combination thereof. In yet another preferred embodiment, the desired pattern includes bands, stripes, circles, polygons including triangles, animals, plants, people, facial features, or abstract symbols, or a combination thereof.

### BRIEF DESCRIPTION OF THE DRAWINGS

Further features and advantages of the invention can be ascertained from the following detailed description that is provided in connection with the drawing(s) described below:

FIG. 1 illustrates a dry-coated, patterned ball-top ice cream cone according to the present invention;

FIG. 2 illustrates several dry-coated, patterned frozen confection stick bars according to the present invention;

FIG. 3 illustrates a dry-coated, patterned frozen confection stick bar with a crossed-line pattern according to the present invention; and

FIG. 4 illustrates a dry-coated, patterned frozen confection stick bar with a letter pattern according to the present invention.

### DETAILED DESCRIPTION OF THE PREFERRED EMBODIMENTS

A process for preparing dry-coated, patterned confectionery products has now been discovered. The inventive process provides a plurality of discrete, non-liquid particles in a visually distinct pattern upon a portion but not all of an outer surface of a confectionery product on at least one side of the confectionery product, wherein the particles are adhered to the portion of the confectionery product to provide the visually distinct pattern compared to the confectionery product. Dry-coated products have also been discovered that have an adhesive coating joined with dry particles to form visually distinctive patterns on the confectionery products. Preferably, the dry particles also provide textural distinctness from the non-patterned surface of the confectionery products.

Any suitable confectionery product can be used in the process and product of the invention, but preferably the product is frozen. Preferred frozen confectionery products include water ices and ice creams, and preferred forms include stick bars, stickless bars (e.g., sandwiches), and cones. In one form, it is preferred to prepare ice cream or water ice products in stick bar form. The confectionery products can be of any desired size or shape, but preferably are sized for consumption by an individual. The products have at least one outer surface that is to be coated with dry particles, and the outer surface can be of any shape including curved or flat. The confectionery products are preferably pre-formed and frozen before further processing according to the invention. The remainder of the processing can take place under any suitable temperature, although preferably within a temperature window of about −10° C. to about 15° C. to permit sufficient processing time for various aspects of the invention. Room temperature or warmer operations, such as 25° C. to 50° C. can also be used.

The particles to be applied are dry, i.e., non-liquid, and therefore drying of the products can be advantageously minimized avoided to expedite the entire coating and patterning process. Suitable particles include any low moisture edible product that can be applied to coat a confectionery product. Exemplary dry particles include cake fragments, cookie fragments, diced nuts, confectionery sprinkles, chocolate vermicelli, candy fines, seeds, or fruit fragments, or a combination thereof. Non-pareils are a preferred dry particle. The particles can be any suitable size. One type of preferred size particles includes larger sizes than conventionally used to coat confectionery products, and these can be from about 2 mm to 8 mm in size. Typically, larger size particles will not necessarily be spherical, but will be wider than they are thick when disposed to minimize accidental undesired removal from the products and to facilitate consumption of the products. One set of preferred dry piece sizes can pass through about size 10 (2,000 microns) to size 14 (1410 microns) mesh screens.

The dry particles can be applied directly to the confectionery product. Alternatively, the confectionery product is first coated, preferably with an adhesive, edible material that is sufficiently tacky to retain the particles thereon. The adhesive material can dry, solidify, or harden over time, and preferably does to help retain the particles to be joined thereto. Any suitable adhesive coating can be used, but preferably the adhesive coating includes an oil-based coating or water-based syrup, or a combination thereof. The adhesive, edible material may have any suitable viscosity that permits it to be disposed on the confectionery product and substantially remain thereon until at least partially dried after the particulates have been placed adjacent thereto. Preferably, the adhesive, edible material has a viscosity of about 5 cPs (0.05 g/cm*s) to 5,000 cPs (50 g/cm*s) as it is applied to a confectionery product, although the viscosity will then rapidly change depending on the temperature of the confectionery product. In a preferred embodiment where the adhesive, edible material is clear and includes up to about 100 weight percent fat content, the viscosity can be from about 5 to 100 cPs. In another preferred embodiment where the material is white or opaque in color and includes about 60 weight percent fat content, the viscosity can be from about 150 cPs to 500 cPs. In yet another preferred embodiment wherein the material is chocolate and has a fat content of about 40 weight percent to 60 weight percent, the viscosity of the material can be from about 250 cPs to 4,000 cPs, preferably from about 400 cPs to 3,000 cPs. Typically, the more fat that is included in the adhesive component, the lower the viscosity value. As temperature also affects viscosity, the viscosity should be measured using a Brookfield viscometer at 40° C. at a single speed (20 rpm). Moreover, the adhesive, edible component can be provided with any desired coloring or flavoring agents to complement or contrast from the color and/or flavor, or both, of the confectionery product over which it is disposed and dry particles that are subsequently disposed.

There are three preferred modes of providing the visual distinctiveness of the dry particles to a confectionery product. These include: (1) providing an adhesive, edible material in the visually distinct pattern that is sufficiently tacky to retain the particles thereon, and adhering the discrete, non-liquid particles onto the tacky pattern to form the partially dry-coated confectionery product; (2) providing particles on the confectionery by dry-coating the outer surface of a confectionery product with a plurality of discrete, non-liquid particles; and selectively removing a sufficient amount of the particles to create a desired pattern of particles that is visually distinct from the confectionery product; (3) providing an adhesive, edible material in a distinct pattern that is sufficiently tacky to retain the particles thereon, adhering the discrete, non-liquid particles onto the tacky pattern, and providing an opaque, edible coating so at to leave exposed the visually distinct pattern of discrete, non-liquid particles to form the partially dry-coated confectionery product; or any combination thereof. Mode (2) can be used in combination with mode (1), for example, to apply an adhesive coating material in a visually distinct pattern and to apply dry particles over an entire product and then remove selected particles, e.g., that do not adhere to the confectionery product or any adhesive coating previously disposed thereon.

The application of an adhesive, edible material can be accomplished through any suitable means with reference to the description of the invention. Preferred methods for applying adhesive, edible material to a confectionery product include one or more of the following: spraying (e.g., through a nozzle, venture or vortex tube, or stencil, or a combination thereof), pad stamping, brushing, spinning a cup, pipe, or disk or the like, by controlled melting of a portion of the outer surface of the confectionery product, or any combination thereof. The controlled melting can be accomplished by any suitable method of melting only a desired portion of the surface of the confectionery that will provide the pattern, such as by directed radiant or conductive heat. With respect to spinning a cup, pipe, disk, or the like, suitable equipment and methods can be used or modified as described in U.S. Pat. Nos. 6,194,014; 6,267,073; and 6,340,488, each of which is hereby incorporated herein by express reference thereto.

The process of preparing confectionery products of the invention can further include covering the confection with a fat-based coating before adhering the discrete-non-liquid particles. The fat-based coating can be the same or different from the adhesive, edible material. When it is a different material, it can be combined with the adhesive, edible component or provided separately. When provided separately, the fat-based coating can be applied as a layer over or under, or next to, the patterned adhesive, edible component.

The dry particles are generally applied after the optional, but preferred, adhesive material and any optional fat-based coating is provided or formed on the confectionery product. The dry particles can be applied by any suitable method. Exemplary application equipment can include screw feeders, vibratory feeders, and pneumatic conveying devices. Preferably, the dry particles are applied by disposing or projecting a shower of discrete particles, or both, onto the outer surface of the confection. It is important that dry particles be provided to all tacky areas on the surface of the confectionery product, both to provide the visually distinct pattern and to help minimize or avoid sticking of any adhesive material to the product packaging. They can be applied over the entire confectionery product, but ultimately will be retained only in the previously disposed or formed pattern. Therefore, the dry particles need not be placed in any particular pattern, as they will be retained wherever the tacky pattern of adhesive material has been previously applied. Conversely, the pattern is preferably at least substantially, or more preferably entirely, covered by dry particles. In various embodiments, the confectionery products can be moved past two separate sources of dry particles of varying color, size, texture, or a combination thereof, or even twice past the same source, which can provide different types of particles on each pass through.

Preferred equipment for applying the dry particulates includes moving the patterned products at least partly in a vessel and directing a stream of dry particulates at the moving products. Preferably, the products are rotating and optionally moving in a horizontal or vertical direction, and the directing is accomplished with one or more flexible tubes. Particulates that do not adhere to the products preferably fall into the bottom of the vessel, where they are recirculated. This recirculation and directing is preferably accomplished by a venturi device, such as that commercially available from Line Vac, although various other equipment can be readily used. The flexible tube(s) can be Y-shaped to provide two points at which particulates are directed at products, which can help provide the particulates on multiple sides of a product at the same time. In the embodiment using a venturi device and a flexible tube, the dry particulate applying equipment does not require any mechanical or moving parts, which renders it less likely to require maintenance and facilitates cleaning thereof.

The visually distinct pattern can include any desired pattern that appears visibly different from the confectionery surface that does not contain the dry-coating particles. The pattern itself can be formed of one or more lines, bands or stripes, circles, alphanumeric characters of any language, polygonal shapes including triangles, animals, plants, people, facial features, or abstract symbols, or a combination thereof. These pattern features can be distinct or overlapping. Visual distinctness can also or additionally be provided by using a plurality of first particles and a plurality of second particles, with first and second particles having different colors, shapes, or both.

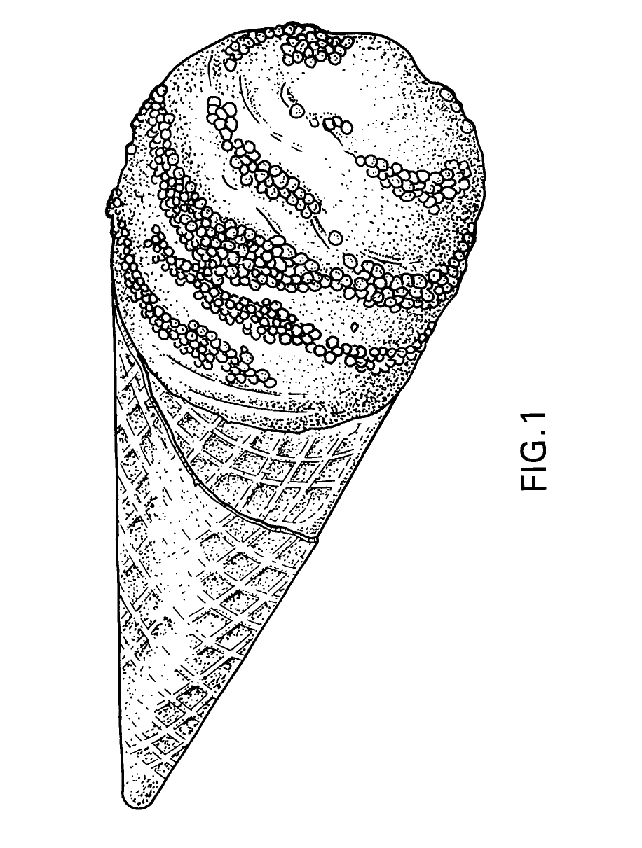

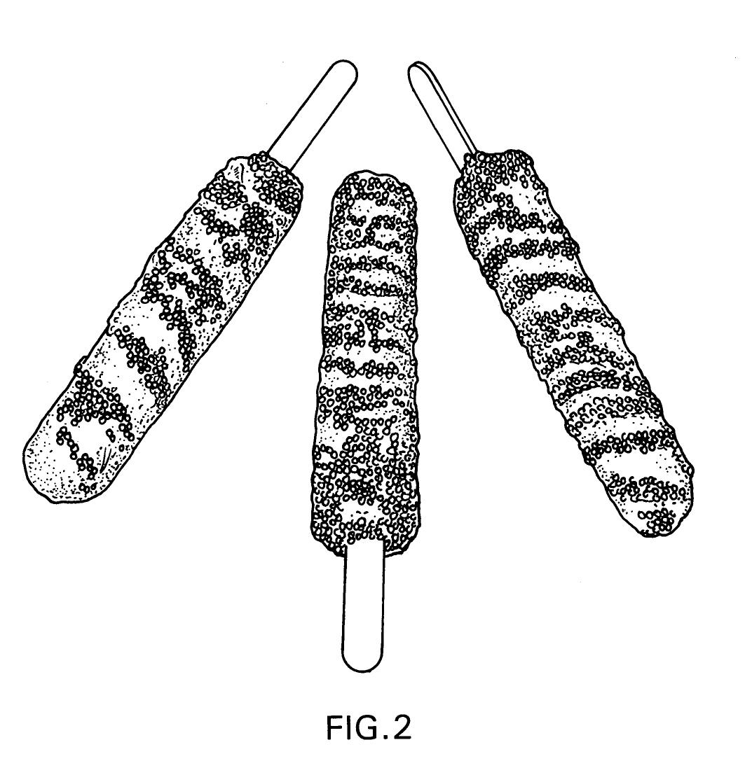

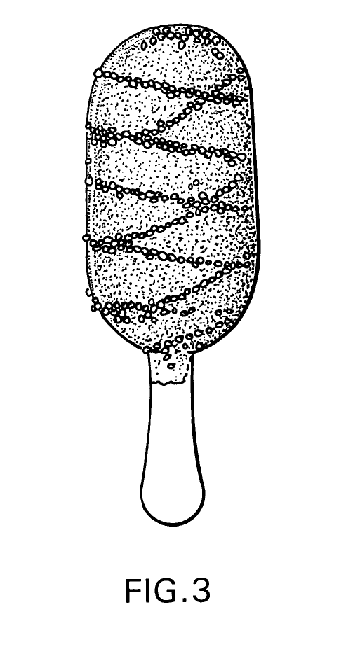

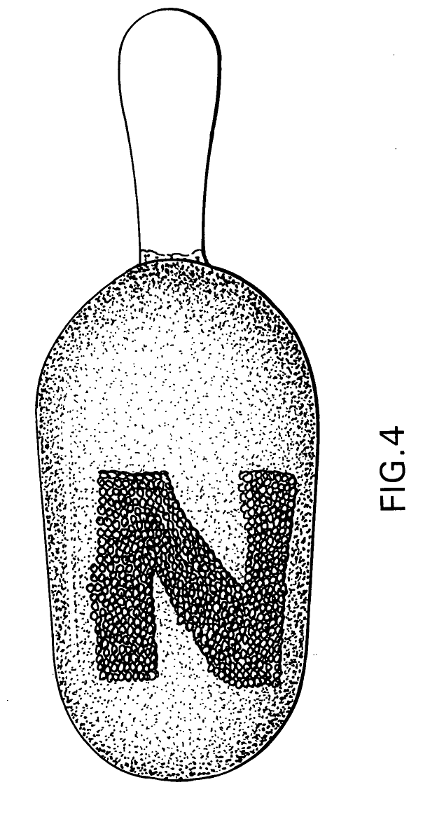

FIGS. 1-3 depict various embodiments of confectionery products according to the invention with various types of dry particles and visually distinct patterns. FIG. 1 depicts a visually distinct pattern on a ball-top ice cream cone in a visual swirl pattern. FIG. 2 depicts a visually distinct pattern on frozen confection stick bars that includes stripes/bars. FIG. 3 depicts a visually distinct crossed-line pattern on frozen confection stick bars. FIG. 4 depicts a frozen confection stick bar that includes a pattern of the letter “N” when the product is held upright by the stick.

The visually distinct pattern is preferably applied while the moving the confectionery products, more preferably by rotating, moving horizontally, or moving vertically, or any combination thereof, the confectionery products relative to the source of adhesive, edible material or dry particles being provided thereon. The moving can occur while providing the visually distinct pattern, while providing the dry particles, or both, while the confectionery product is in motion. Preferably, the confectionery products are moving laterally (rather than transversely) to the dry particle source and the source of the adhesive, edible material during application. The pattern is preferably provided on at least one side, and more preferably on at least two different sides, of the confectionery product and the particles are also applied concurrently onto the different sides of the confectionery product to help provide the visually distinct pattern. In another embodiment, the particles that are applied are first particles having a first appearance, and the process further includes sequentially applying a plurality of second particles having a second appearance that visually contrasts with the first particles.

When the preparation mode is used where excess or undesired dry particles are selectively removed to provide the visually distinct pattern, this can be done by any suitable method. Preferred methods include directing an air flow at the particles, suctioning the particles, brushing the particles, scraping the particles, or a combination thereof. Then, for all embodiments, it is preferable to retain the visually distinct pattern in place until the confectionery product reaches the ultimate consumer. This can be accomplished by ensuring that enough particles are permanently attached to the tacky adhesive, edible material in a manner sufficient to retain at least about 95 percent, preferably at least about 98 percent, and more preferably at least about 99 percent of the particles as placed adjacent the confectionery product. Also, the visually distinct pattern does not cover the entire outer surface of the product, as this would not provide “visual distinctness” according to the invention. Preferably, the dry particles are visible on an area that covers about 1 percent to 80 percent, preferably about 2 percent to 40 percent, of the outer surface of a confectionery product.

Once the visually distinct pattern is provided to the confectionery product, it is preferred to wrap or otherwise package the product for storage and/or transport. Before packaging, it is preferred to wait a short period of time between preparing the confectionery article and packaging to ensure the adhesive, edible material is sufficiently dried, solidified, or hardened so that it is substantially or entirely tack-free with respect to the packaging material. This helps minimize or avoid sticking of the patterned edible material to the packing material.

The dry-coated, patterned frozen confectionery product of the invention can be prepared as described above. These products include a frozen confectionery product, a dried adhesive coating deposited in a desired pattern adjacent an outer surface of a confectionery product; and a plurality of discrete particles placed adjacent the adhesive coating and opposite the adhesive coating from the confectionery product, which are sufficiently adhered thereto to substantially remain affixed to the product in a visually distinct pattern. Preferably, the discrete particles also provide a raised texture to the outer surface of the confectionery product. Various embodiments noted above can also be present in the final dry-coated, patterned confectionery product. For example, a fat-based coating can be provided upon an outer surface portion of the confectionery product, preferably between the dry particles and the product itself. Preferably, any such fat-based coating includes chocolate, a substantially transparent material, or both. The fat-based coating can be the dried adhesive coating or a separate or adjacent layer of material. For example, a substantially transparent material can be applied over the adhesive coating and dry particles to help retain and protect the particles and visually distinct pattern on the confectionery product.

### EXAMPLES

The following examples are not intended to limit the scope of the invention, but merely to illustrate representative possibilities concerning the present invention.

### Example 1

### Coated Ice Cream Bars Decorated with Lines of Coconut Per the Invention

Extruded ice cream bars were dipped in a white, fat-based coating of Formulation 1 at 35° C. Approximately 9 to 15 seconds after dipping, when the coating has stopped dripping but before it is completely dried, the bars are decorated with thin lines of the same white, fat-based coating to provide a raised texture. Approximately 3 to 6 seconds after applying the adhesive coating lines, the bars are passed through a falling shower of toasted coconut. The coconut included was fine granules of sweetened, toasted coconut. The coconut pieces stick only to the lines of coating, but not to the other non-adhesive surfaces of the bars, to form a patterned dry-coated bar according to the invention. After a minimum of 6 to 12 seconds pass, the coconut-coated patterned bar can be packaged using conventional techniques without noticeable sticking to the packaging.

### Example 2

### Water Ice Bars with Lines of Multicolored Non-Pareils Per the Invention

Molded water ice bars are dipped in cold water at 5° C. Approximately 3 to 6 seconds after water dipping, the bars are decorated with lines of clear, fat-based coating of Formulation 2 in a selected pattern at 40° C. Approximately 3 to 6 seconds after applying the adhesive lines, the bars are passed through a falling shower of multi-colored non-pareils. The non-pareils selected were of assorted size 12/14, such as those commercially available from QA Products of Elk Grove Village, Ill. The non-pareils stick only to the lines of adhesive coating, but not to the other water-coated surfaces of the bars, to form a patterned dry-coated bar according to the invention. After a minimum of 6 to 12 seconds pass, the dry-coated patterned bar can be packaged using conventional techniques without noticeable sticking to the packaging.

### Example 3

### Coated Stick Bars with Yellow Non-Pareils in Circle Patterns Per the Invention

Extruded ice cream bars are passed through an enrobing trough containing milk chocolate-flavored coating of Formulation 3 at 35° C. Approximately 15 to 24 seconds after coating, the bars are passed beside a rotating drum stenciler with 25 mm diameter circular holes that sprays chocolate flavored fat-based coatings of Formulation 4 at 50° C. onto one side of each bar. Approximately 3 to 6 seconds after applying the stencil, the bars are tilted 45 degrees to horizontal and passed beneath a gently falling curtain of yellow non-pareils, such as commercially available from QA Products as noted in Example 2. These yellow non-pareils stick to the stenciled circle but not to the other non-adhesive surfaces of the bar, i.e., there is no sticking of yellow non-pareils to the milk chocolate-flavored coating on the ice cream bars. After a minimum of 12 to 24 seconds pass, the dry-coated, patterned bar can be packaged using conventional techniques without noticeable sticking to the packaging.

| Formulation\ | 1 | 2 | 3 | 4 |
|---|---|---|---|---|
| Coating Component | White | Clear | Chocolate | Chocolate |
| Sugar | 34.9 | — | 41.9 | 39 |
| Non-fat dried milk | 5 | — | 3 | — |
| Cocoa powder | — | — | 10 | 6 |
| Flavor | 0.1 | — | 0.1 | — |
| Coconut oil | 58.5 | 10 | 41.5 | 53.5 |
| Soybean oil | 1 | 89 | 3 | 1 |
| Lecithin | 0.5 | 1 | 0.5 | 0.5 |

The term “about,” as used herein, should generally be understood to refer to both numbers in a range of numerals. Moreover, all numerical ranges herein should be understood to include each whole integer within the range.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

What is claimed is:

1. A process for preparing a partially dry-coated confectionery product which comprises moving the confectionery products while providing a plurality of discrete, non-liquid particles in a visually distinct pattern upon a portion but not all of an outer surface comprising at least one side of the confectionery product, wherein the particles are adhered to the portion of the confectionery product to provide the visually distinct pattern compared to the outer surface of the confectionery product.

2. The process of claim 1, wherein the particles are provided on the confectionery by:
providing an adhesive, edible material in the visually distinct pattern that is sufficiently tacky to retain the particles thereon; and
adhering the discrete, non-liquid particles onto the tacky pattern to form the partially dry-coated confectionery product.

3. The process of claim 2, which further comprises covering the confection with a fat-based coating before adhering the discrete-non-liquid particles.

4. The process of claim 2, wherein the pattern is provided by spraying, pad stamping, brushing, or a combination thereof, the adhesive, edible material onto the confectionery product in the visually distinct pattern.

5. The process of claim 4, which further comprises providing the pattern using a stencil, spinning cup, spinning disk, or spinning pipe.

6. The process of claim 2, wherein the pattern is provided by controlled melting of a portion of the outer surface of the confectionery product to provide the adhesive, edible material to which the discrete, non-liquid particles adhere.

7. The process of claim 2, wherein the particles are applied by at least one of disposing or projecting a shower of discrete particles onto the outer surface of the confection.

8. The process of claim 2, which further comprises moving the confectionery product laterally relative to the particles while providing the pattern, applying the particles, or both.

9. The process of claim 8, wherein the moving comprises rotating, moving horizontally, moving vertically, or a combination thereof.

10. The process of claim 2, wherein the pattern is provided on at least two different sides of the confectionery product and the particles are applied onto the pattern concurrently onto the at least two different sides of the confectionery product.

11. The process of claim 2, wherein the particles that are applied are first particles having a first appearance, and which further comprises sequentially applying a plurality of second particles having a second appearance that visually contrasts with the first particles.

12. The process of claim 2, which further comprises drying the adhesive, edible material and surrounding the coated product in a packing material, with sufficient drying to avoid sticking of the patterned edible material to the packing material.

13. The process of claim 1, wherein the particles are provided on the confectionery by dry-coating the outer surface of a confectionery product with a plurality of discrete, non-liquid particles; and selectively removing a sufficient amount of the particles to create a desired pattern of particles that is visually distinct from the confectionery product.

14. The process of claim 13, wherein the selective removing comprises directing an air flow at the particles, suctioning the particles, brushing the particles, scraping the particles, or a combination thereof.

15. The process of claim 13, wherein the visual distinctness comprises providing a plurality of first particles and a plurality of second particles with different colors, shapes, or both.

16. The process of claim 1, wherein the particles are provided on the confectionery by:
providing an adhesive, edible material in a different pattern that is sufficiently tacky to retain the particles thereon;
adhering the discrete, non-liquid particles onto the tacky pattern; and
providing an opaque, edible coating so at to leave exposed the visually distinct pattern of discrete, non-liquid particles to form the partially dry-coated confectionery product.

17. The process of claim 1, wherein the particles are permanently attached to the tacky adhesive, edible material.

18. The process of claim 1, wherein the particles are provided so as to also impart textural distinctness from the outer surface of the confectionery product.

19. A dry-coated, patterned frozen confectionery product comprising:
a dry, adhesive coating deposited in a desired pattern adjacent an outer surface of a confectionery product; and
a plurality of discrete particles placed adjacent the adhesive coating and opposite the adhesive coating from the confectionery product, which are sufficiently adhered thereto to substantially remain affixed to the product in a visually distinct pattern.

20. The product of claim 19, wherein the discrete particles provide a raised texture to the outer surface of the confectionery product.

21. The product of claim 19, wherein a fat-based coating is provided upon an outer surface portion of the confectionery product.

22. The product of claim 19, wherein the fat-based coating comprises chocolate, a substantially transparent material, or both.

23. The product of claim 19, wherein the adhesive coating comprises an oil-based coating or water-based syrup, or a combination thereof.

24. The product of claim 19, wherein the particles comprise cake fragments, cookie fragments, diced nuts, confectionery sprinkles, chocolate vermicelli, candy fines, seeds, or fruit fragments, or a combination thereof.

25. The product of claim 19, wherein the desired pattern comprises bands, stripes, circles, polygons including triangles, animals, plants, people, facial features, or abstract symbols, or a combination thereof.
